(19) United States
(12) Patent Application Publication
(10) Pub. No.: US 2006/0227145 A1
(43) Pub. Date: Oct. 12, 2006

(54) Graphics controller having a single display interface for two or more displays

(76) Inventors: Raymond Chow, Richmond (CA); Jimmy Kwok Lap Lai, Vancouver (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 11/099,943

(22) Filed: Apr. 6, 2005

(51) Int. Cl. G09G 5/399

(52) U.S. Cl. 345/540

(57) ABSTRACT

The invention, in one preferred embodiment, is directed to a method for fetching image data from a memory for transmission on a data bus to at least two display devices. First portions of a first frame are fetched at a non-interleaving fetch rate in response to receiving a first signal. Second portions of a second frame are fetched at the non-interleaving fetch rate in response to receiving a second signal. The timing of the first and second signals are asynchronous to one another. The non-interleaving fetch rate is adjusted to an interleaving fetch rate in response to performing fetching the second portions.

### FIELD OF THE INVENTION

The present invention relates to graphics display systems, and more particularly to a graphics controller, for use in a graphics display system, having a single display interface for supporting two or more display devices.

### BACKGROUND

Graphics display systems typically employ a graphics controller as an interface between a graphics display device and one or more providers of image data. Commonly, in a graphics display system the providers of image data are a host and a camera. The host and camera each transmit image data to the graphics controller, and the graphics controller then transmits image data to the display device.

Generally, the graphics controller includes an internal memory for storing the image data it receives. Before transmitting image data to the display device, the graphics controller processes the image data. For example, the graphics controller may compress or decompress image data. In addition, the graphics controller may crop, resize, scale, and color convert the image data according to one of a number of alternative color conversion schemes.

Mobile telephones and other portable graphics display systems may have two or more display devices, such as, for example, a main display and an auxiliary display. The main display is used for displaying image data from the camera, the host, or both. The auxiliary panel is used for displaying image data provided by the host. The main display has a display screen that is typically larger than the display screen of the auxiliary display. Camera images and video game graphics are displayed, for example, on the main display while the auxiliary panel is used for displaying image data, such as time, date, and the telephone number of an incoming caller.

In graphics display systems which have two or more display devices, it is generally a requirement for the graphics controller to have a display interface for each display. The reason for this requirement is to prevents conflicts between the sources. For example, the host can transmit image data to the auxiliary panel using one display interface while the camera can simultaneously transmit image data to the main panel using the other display interface without there ever being a conflict over the use of a single display interface.

In battery-powered portable graphics display systems, however, there is an ever present need to minimize power consumption. Further, there is a need to minimize the size of the graphics controller integrated circuit (“IC”). A graphics controller that could use a single display interface to support two or more display panels would be desirable to help achieve these goals.

One method for preventing conflicts when two sources of image data simultaneously want to transfer data over a single display interface is to add a memory to the graphics controller for temporarily buffering the data of one of the sources. However, the advantage of not having to use two display interfaces tends to be offset by the disadvantage of increasing memory requirements.

Accordingly, a graphics controller that uses a single display interface to support two or more display devices is needed.

### SUMMARY

The invention, in one preferred embodiment, is directed to a method for fetching image data from a memory for transmission on a data bus to at least two display devices. First portions of a first frame are fetched at a non-interleaving fetch rate in response to receiving a first signal. Second portions of a second frame are fetched at the non-interleaving fetch rate in response to receiving a second signal. The timing of the first and second signals are asynchronous to one another. The non-interleaving fetch rate is adjusted to an interleaving fetch rate in response to performing fetching the second portions.

In another preferred embodiment, the invention is directed to a graphics controller for fetching image data for transmission on a data bus to at least two display devices in response to receiving respective signals for each of the display devices. At least one of the signals is generated asynchronously to the other signals. The graphics controller comprises a memory for storing first and second frames of image data, a display interface for fetching first portions of a first frame at a non-interleaving fetch rate in response to detection a first signal, and fetching second portions of a second frame at the non-interleaving fetch rate in response to detection of a second signal, and a rate controller for adjusting the non-interleaving fetch rate to an interleaving fetch rate in response to detection of the second signal while fetching first portions.

The invention is also directed, in another preferred embodiment, to a graphics display system for transmitting image data from at least two image sources to at least two display devices. The system comprises a first data source for generating a first frame of image data, a second data source for generating a second frame of image data. The second data source generates image data asynchronously to the first data source. In addition, the system includes a first display device, a second display device, and a graphics controller coupled with the first and second data sources, and with the first and second display devices. The graphics controller includes a memory for storing the first and second frames, a display interface for fetching from the memory first portions of the first frame at a non-interleaving fetch rate upon the completion of storing of the first frame in the memory, and fetching second portions of the second frame at the non-interleaving fetch rate upon the completion of storing of the second frame in the memory, and a rate controller for adjusting the non-interleaving fetch rate to an interleaving fetch rate upon the completion of storing of the second frame while fetching first portions.

In yet another embodiment, the invention is directed to a medium readable by a machine embodying a program of instructions executable by the machine for performing a method for fetching image data from a memory for transmission on a data bus to at least two display devices. First portions of a first frame are fetched at a non-interleaving fetch rate in response to receiving a first signal. Second portions of a second frame are fetched at the non-interleaving fetch rate in response to receiving a second signal. The timing of the first and second signals are asynchronous to one another. The non-interleaving fetch rate is adjusted to an interleaving fetch rate in response to performing fetching the second portions.

### BRIEF DESCRIPTION OF THE DRAWINGS

FIG. 1 is a block diagram of a graphics display system according to the present invention.

FIG. 2 is a timing diagram for the graphics display system of FIG. 1 illustrating the storing and fetching of camera image data.

FIG. 3 is a timing diagram for the graphics display system of FIG. 1 illustrating the fetching of host image data at first point in time to show a problem solved by the invention.

FIG. 4 is a timing diagram for the graphics display system of FIG. 1 illustrating the fetching of host image data at second point in time to show a problem solved by the invention.

FIG. 5 is a timing diagram for the graphics display system of FIG. 1 showing host image data transfer requests at different points in time according to the invention.

### DETAILED DESCRIPTION OF PREFERRED EMBODIMENTS

The invention is directed to a graphics controller for use in a graphics display system, the graphics controller having a single display interface to support two or more display devices. The invention is also directed to a system and a method for supporting two or more display devices with a single display interface. Reference will now be made in detail to preferred embodiments of the invention, examples of which are illustrated in the accompanying drawings. Wherever possible, the same reference numbers are used in the drawings and the description to refer to the same or like parts.

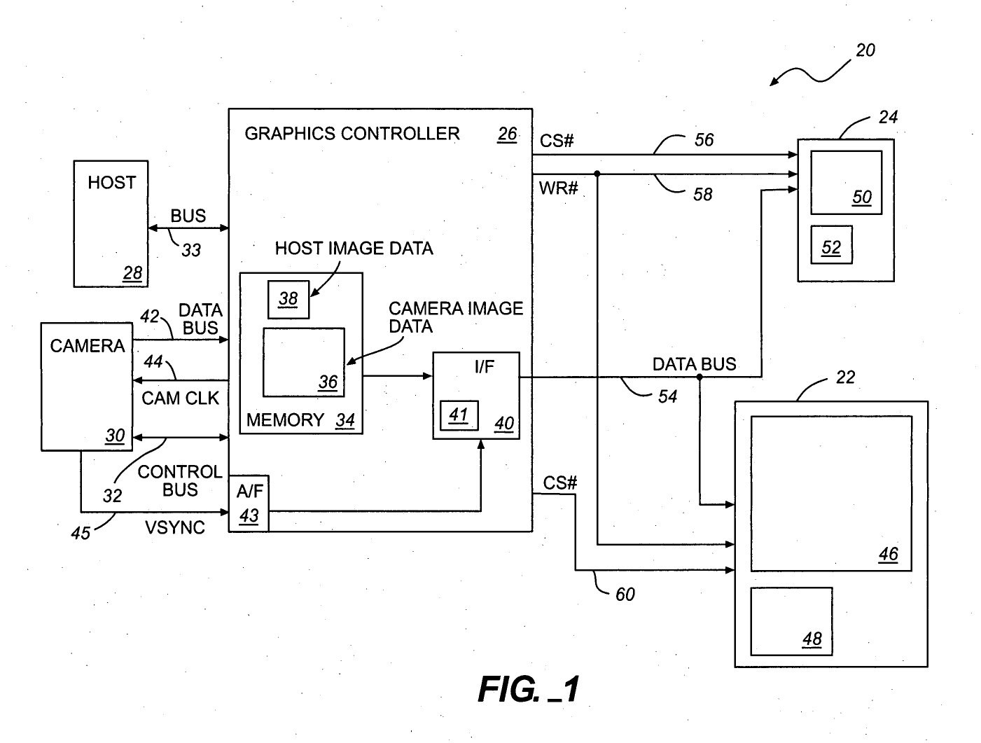

FIG. 1 depicts a graphics display system 20 that illustrates one preferred embodiment of the invention. The system 20 includes a main display device 22, an auxiliary display device 24, a graphics controller 26, a host 28, and an image capture device 30. The system 20 may be any digital system or appliance providing graphics output. Preferably, the system 20 is a battery powered (not shown) portable appliance, such as a mobile telephone.

The host 28 is preferably a CPU or DSP, and the image capture device 30 is preferably a camera. However, the invention is not limited to devices of these specific types. Any types of providers of image data are contemplated as being within the scope of the invention.

The graphics controller 26 provides a mechanism for the host 28 to control the camera 30. The camera may be programmed, for example, to send display frames of image data in different resolutions to the graphics controller. The camera is programmed via a serial control bus 32. The host specifies parameters, such as camera resolution, by transmitting control data over a parallel bus 33 to the graphics controller, which the graphics controller then uses to program the camera over the serial bus 32.

The graphics controller 26 includes an internal memory 34 for storing image data. Image data for display on the main display device 22 is designated by reference number 36. The image data 36 are created by the camera (also referred to herein as “camera image data”). Image data for display on the an auxiliary display device 24 is designated by reference number 38. The image data 38 are created by the host (also referred to herein as “host image data”).

The host image data 38 are stored in the memory 34 as a result of the host issuing a command (or commands) and transferring the data to the graphics controller on the bus 33. In a similar fashion, the camera image data 36 are stored in the memory 34 as a result of the host first programming (via the graphics controller) the camera to generate a stream of display frames of image data, and then programming the graphics controller to store the camera image data.

Whether provided by the host 28 or the camera 30, the image data 36, 38 are typically presented to the graphics controller in a raster order. “Raster order” refers to a scan pattern in which an area is scanned from side to side in rows from top to bottom. The graphics controller stores the image data 36, 38 in the internal memory in the same raster order in which the data are presented.

The graphics controller provides a camera clock signal 44 (“CAM CLK”) to the camera. In addition, the camera 30 generates a VSYNC signal on a line 45, which is provided to the graphics controller.

The main display device 22 has a display screen 46 and an internal memory 48 for storing a display frame of image data. Similarly, the auxiliary display device 24 has a display screen 50 and an internal memory 52 for storing a display frame of image data. While the display devices 22, 24 are typically liquid crystal displays (“LCD”), they may be any device capable of rendering image data, including CRT and OLED display devices, as well as hard copy rendering devices, such as printers.

In this description, preferred embodiments and examples described are described with reference to two display devices, 22 and 24. The display devices 22 and 24 provide context and help illustrate the principles of the invention. However, it should be understood that the principles of the invention is not limited to two display devices and may be applied for use with 3 or more display devices.

The graphics controller 26 includes a display interface (“I/F”) 40 for fetching image data from memory and transmitting it to the display devices according to the invention. The graphics controller 26 transmits image data to the display panels 22, 24 on a data bus 54, as shown in FIG. 1. The graphics controller 26 also includes a rate controller 41, which may be included within the display interface 40, or which may be a separate block.

The host image data 38 are fetched from memory and transmitted to display panel 24 on the bus 54 as a result of a command (or commands) by the host 28. The camera image data 36 are also fetched from memory and transmitted to display panel 22 on the bus 54 on as a result of a command (or commands) by the host 28.

The display interface 40 transmits image data by placing image data 36 or 38 on the bus 54, selecting display 22 or 24, and issuing a write command. In a preferred embodiment, a particular display device is selected by asserting the chip select signal (CS#) on either line 56 or 60. The line 56 runs between the graphics controller and the auxiliary display device 24, and the line 60 runs between the graphics controller and the main display device 22. In an alternative embodiment, the chip select signal is provided by the graphics controller on a single line that is coupled to both panels, and inverter is placed in series before one of the display devices so that when the chip select signal is asserted, one panel is selected while the other is de-selected. The write command (WR#) is issued using a line 58, which runs between the graphics controller and the two display devices.

The camera 30 provides the camera image data 36 in a stream of display frames. The host 28 may monitor the generation of display frames by the camera 30, and after each frame has been generated and stored in memory, request that the graphics controller 26 fetch the camera image data 36 from the internal memory and transmit it to the display panel 22. However, this is a burden on the host.

Alternatively, the graphics controller 26 includes an auto-frame transfer module 43 (“A/F”). The host 28 programs auto-frame transfer module so that the camera image data 36 is automatically fetched from memory 34 and transmitted to the display 22. After generating each display frame, the camera generates the VSYNC signal on line 45. Under this alternative, the auto-frame transfer module 43 monitors VSYNC and triggers the display interface 40 to fetch and transfer image data when the signal is detected. This relieves the host of the burden of having to monitor the transmission of each camera display frame, as well as the need to repeatedly request the graphics controller to transmit display frames to the display panel.

In general, graphics controllers transmit image data to display devices in conformity with a timing protocol required by the device. Traditionally, the display timing protocol is relatively strict. However, some display devices are provided with an internal memory for storing a display frame of image data, and these devices are capable of receiving data under a more relaxed timing protocol. Display devices with internal memory also include circuitry for refreshing the device's display screen from the on-board memory.

As mentioned, the display devices are provided with internal memory. The display devices 22 and 24 are capable of receiving data under a timing protocol which is more relaxed than that required for traditional display devices. In addition, the display devices 22, 24 include circuitry (not shown) for refreshing the display screen from the on-board memory. When the image data 36, 38 are fetched from the internal memory 34 and written to the display devices, the image data 36 are stored in the internal memory 48 for display on the display screen 46, and the image data 38 are stored in the internal memory 52 for display on the display screen 50.

The amount of the memory 36 for storing camera image data 36 is limited to the size of a single camera display frame in the graphics controller 26. In other words, the same portion (or address space) of memory is used for storing each frame in the sequence of frames generated by the camera.

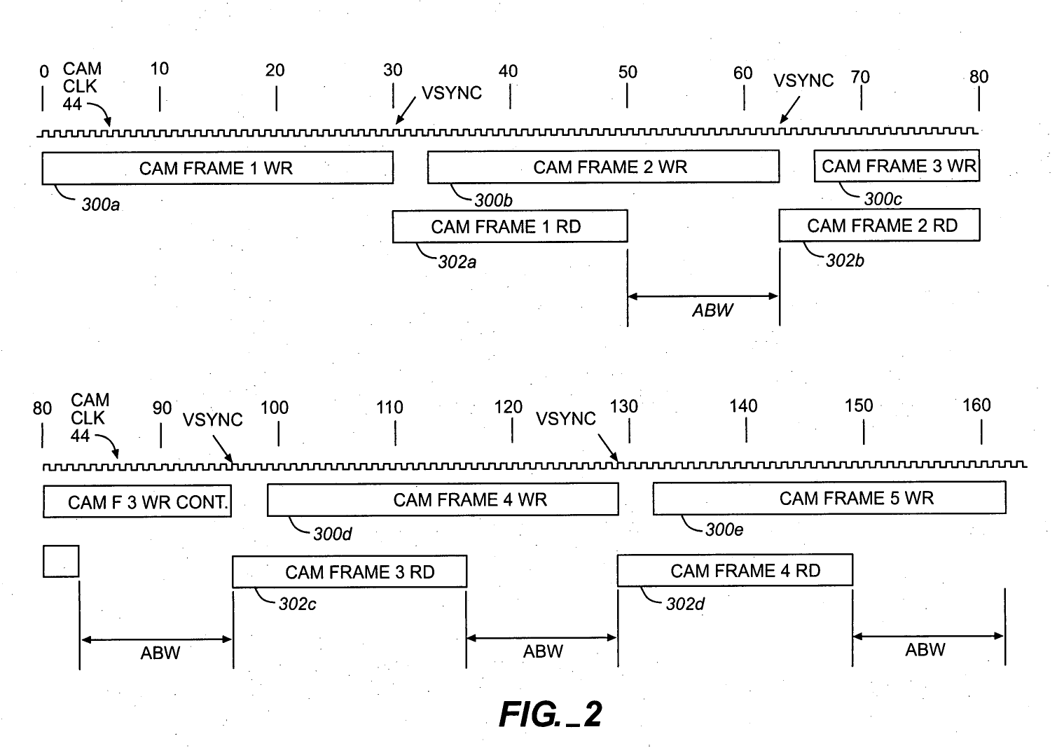

The size of the internal memory 34 in the graphics controller provided for the camera image data 36 is preferably limited to the size of a single camera display frame. This can be done provided: (a) the fetching of a first frame begins before the storing of a subsequent frame; and, generally speaking, (b) the first frame is fetched at a rate greater than or equal to the rate at which the subsequent frame is stored. Under these conditions, the storing of a subsequent frame will not overtake the fetching of the first frame, and a memory the size of a single frame may be used both for storing a first frame and a subsequent frame. As described below with reference to FIG. 2, it will be seen that in the system 20, during periods when only the camera image data is stored and fetched: (a) the fetching of a stored first frame begins before the storing of each subsequent frame; and (b) the camera image data of each subsequent frame is stored at a rate slower than the rate at which the first frame is fetched.

FIG. 2 is a timing diagram, for the graphics display system 20, illustrating the storing and fetching from the memory 34 of the camera image data 36. The timing is shown with respect to CAM CLK 44. FIG. 2 shows the storing of display frames of camera image data 36 represented by blocks 300a, 300b, 300c, 300d, and 300e. These blocks are also labeled “CAM FRAME 1 WR” for the writing of a first camera frame, and so on. FIG. 2 also shows the fetching of these display frames of camera image data 36, represented by the blocks 302a, 302b, 302c, and 302d. These blocks are also labeled “CAM FRAME 1 RD” for the fetching of a first camera display frame, and so on.

FIG. 2 is a simplified timing diagram in which the exemplary frames have 10 pixels each and 3 CAM CLK cycles are needed to store a pixel and 2 CAM cycles are needed to fetch a pixel. FIG. 2 is presented for purposes of illustrating the principles of the invention. It will be appreciated that the same principles apply to frames having substantially more pixels, as well as numerically different storing and fetching cycles.

In the example, the time required to store a display frame of camera image data is 30 periods of CAM CLK 44. At the end of each frame, the camera asserts VSYNC. The camera provides a vertical non-display period of 3 clock periods between successive frames. In addition, 20 periods of CAM CLK 44 are required to fetch each frame. The fetching of each frame begins immediately after the storing of the frame is complete. Because (a) the fetching of each frame begins before the storing of a subsequent frame, and (b) the frames are fetched at a rate greater than CAM CLK 44 rate, the amount of memory for storing the camera image data 36 may be limited to the size of a single camera frame.

FIG. 2 also shows the available bandwidth (“ABW”) for fetching the host image data 38 from the memory 34. For example, beginning with the 51^{st} period of CAM CLK 44 and continuing through the 63^{rd} CAM CLK, the display interface 40 can fetch host image data 38 without there being a conflict with the fetching of camera image data image data 36, that is, without there being a conflict with the fetching of display frames 302a and 302b. Since, in this example, fetching a pixel takes 2 CAM cycles, 6 pixels of image data 38 may theoretically be fetched in the available bandwidth.

Generally, camera image data must be stored as it is received. The camera outputs image data in a stream synchronized with the camera clock signal 44, and the image data is stored in the internal memory 34. If, while capturing a continuous stream of image data, the graphics controller were to program the camera to speed up, slow down, or pause the camera output, undesirable visual artifacts would generally result. The reason is that the camera needs time to adjust and compensate the gain and balance of an internal image sensor. So reprogramming the camera while capturing a stream of image data may cause several seconds of unstable frames. Further, there can be a significant time lag between when the graphics controller sends a command to the camera and when the camera begins to respond to the command. The lag is due to the fact that the camera is programmed over the relatively slow serial bus 32. Thus, speeding up, slowing down, or pausing the camera output is generally impractical during the capture of a continuous stream of image data. Accordingly, in order to prevent artifacts, the image data from the camera generally must be stored as it is received or it will be lost.

The camera 30 operates asynchronously to the host 28. The image data 36 from the camera is stored in the internal memory 34 at the same speed as the camera clock signal 40. The host communicates with the graphics controller over the bus 33, which operates under a clock speed different from camera clock signal 40. The host is unaware of the camera clock signal 40, as well as the time periods when the camera is transmitting image data. In order to learn whether camera data is being transferred at a particular point in time, the host must poll the graphics controller or the graphics controller must provide the information on its own initiative.

As mentioned, the auxiliary panel 24 may be used for displaying time, date, and the telephone number of an incoming caller. This type of information does not need to be updated as often as successive camera images or video. For example, the host 28 may wish to update the auxiliary panel 24 only when the time to be displayed changes, e.g., once a minute or when an incoming call is received. Accordingly, the host will present the host image data 38 to the graphics controller only when one of these events occur, which could be at any time. After the image data 38 are stored in the internal memory 34, the host 28 will then request that the host image data be fetched from the memory and written to panel 24.

From the foregoing, it is apparent that requests by the host to fetch and transmit host image data 38 are a certainty. However, the times when these requests will be made are uncertain. The unpredictability of these requests makes the flexibility to handle such requests at any time a desirable feature of a display interface adapted for supporting a plurality of display devices. As will be seen below, a display interface 40 according to the invention provides this flexibility.

As mentioned, speeding up, slowing down, or pausing the camera output is generally impractical and results in visual artifacts. Therefore, accommodating the timing of host requests that host image data be fetched from the memory and written to panel 24 by speeding up, slowing down, or pausing the camera output is not practical.

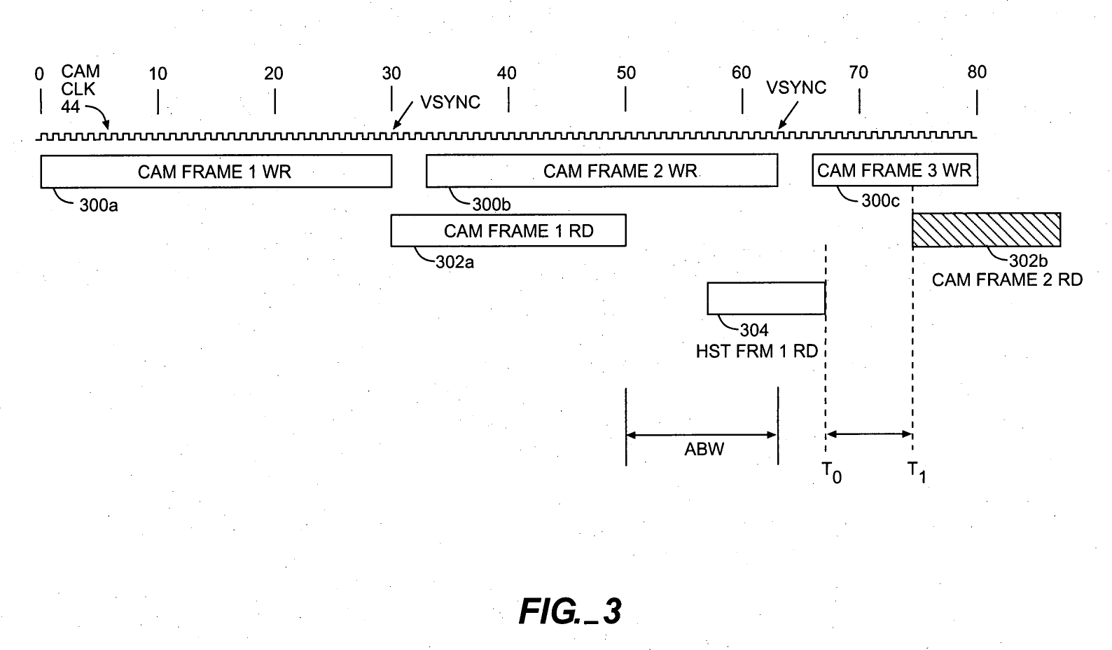

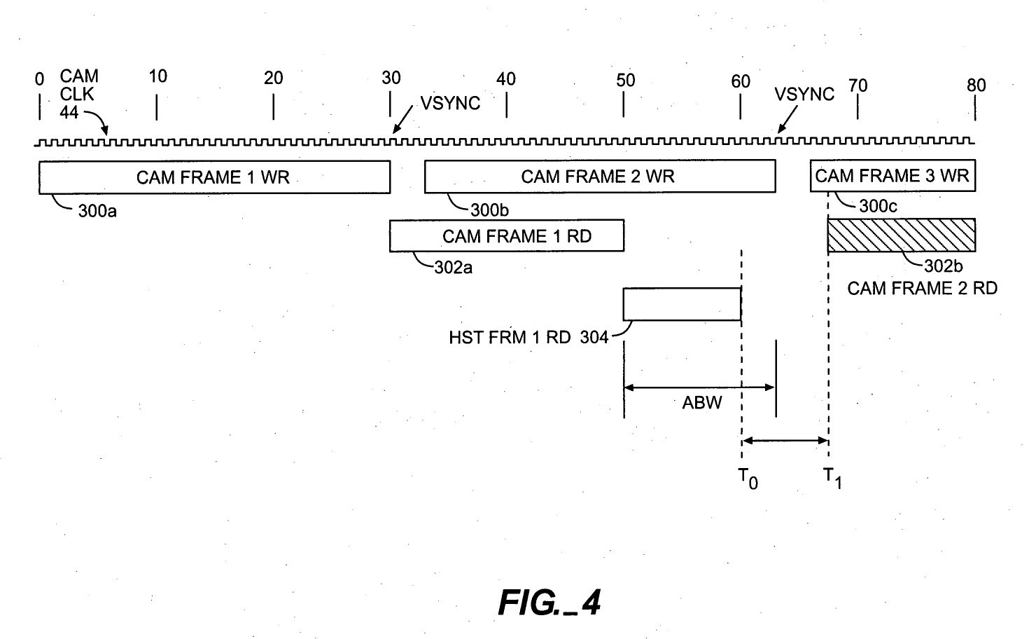

Requests for transfer of host image data 38 at two different points in time are shown in FIGS. 3 and 4. While the FIGS. 3 and 4 are timing diagrams for the graphics display system 20, they are intended to illustrate problems solved by the invention. Accordingly, in the FIGS. 3 and 4, it should be understood that the display interface 40 does not operate according to the invention. With respect to FIGS. 3 and 4 only, it should be recognized that the graphics display system 20 operates like a prior art display system. It may be assumed that the novel features of the display interface 40, described later, are disabled in order to show problems solved by the invention.

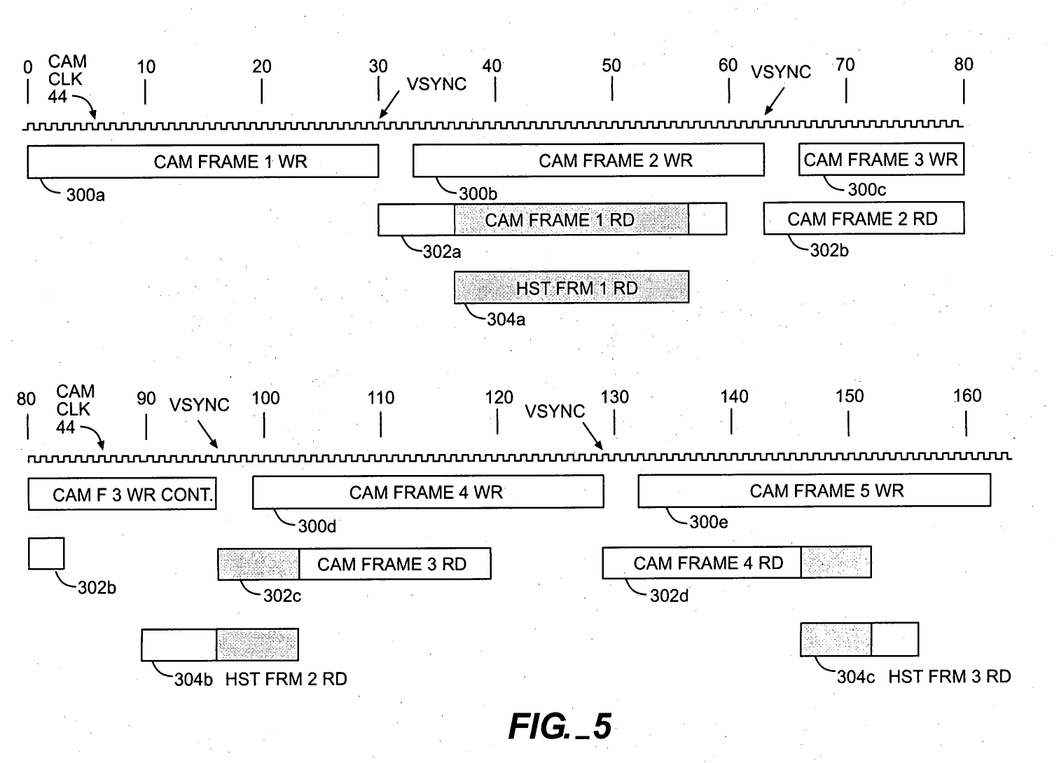

In these examples, a frame 304 of host image data 38 is assumed to be 5 pixels in size. The figures also show the same storing and fetching from the memory 34 of the camera image data 36 that is shown in FIG. 2. Again, it should be noted that the examples of FIGS. 4 and 5 are presented for purposes of illustration.

It should be understood that the frames of camera image data 36 are typically display frames. That is, they comprise all of the pixels in a display screen arranged in raster sequence. Often the frames of host image data 38 are also display frames. However, this is not a requirement. For example, a frame host image data 38 may comprise only the subset of pixels in a display screen which have changed from a previous frame. The use of the word “frame” herein is intended to refer to either all or a subset of the pixels of a display frame.

Referring first to FIG. 4, the host requests the fetching of a frame of host image data 38, designated by reference number 304 and also denoted “HST FRM 1 RD.” The host requests the fetching at a time of CAM CLK cycle 57. This is 7 clocks after the display interface 40 finishes fetching camera frame 302a. The fetching of frame 304 is compete at T₀. However, T₀ is after the graphics controller has started storing camera frame 300c. This creates a problem that is described below.

Before describing the problem, notice that a “latency” period is shown in FIG. 3. The display interface 40 begins fetching the camera frame 302b at the time T₁. The period between T₀, when fetching of the auxiliary frame 304 is complete, and T₁, fetching camera frame 302b begins is the latency period. The latency period represents the time required for the host (or auto-frame transfer module 43) to signal the display interface 40 to switch from fetching host image data 38 to fetching camera image data 36.

The host may monitor generation camera frames, and after a frame has been generated, request that the graphics controller fetch the camera data 36. Alternately, the host may program the auto-frame transfer module 43 to automatically perform the fetching. The latency period represents the time required for the host to perform either of these alternative tasks. Depending on a number of factors, the latency period will vary in different embodiments and may vary within a particular embodiment. For instance, the host may be idle at one time and busy at another time.

A significant problem occurs if the display interface 40 begins fetching camera frame 302b after the graphics controller has begun storing camera frame 300c at time T₁ as shown in FIG. 3. The display interface 40 fetches pixels in raster order. However, frame 300c will have overwritten part of the pixels of frame 300b at the time T₁. Pixels from frame 3 will be presented to the display panel as if they were part of frame 2. The corrupted frame 2 results in an artifact known as “image tearing.” As described below, this is not the only possible artifact.

FIG. 3 shows that the display interface 40 begins fetching the camera frame 302b at T₁. Alternatively, (and typically where the auto-frame transfer module 43 is employed) the camera frame 2 (300b and 302b) is simply dropped. That is, the camera frame 2 is never sent to the display panel. By the time the host programs the graphics controller to automatically fetch camera data 36, the VSYNC signal monitored by the auto-frame transfer module 43 has already been issued for the camera frame 2. The auto-frame transfer module 43 misses the VSYNC signal. Dropping a full camera frame also produces an undesirable display artifact.

Referring now to FIG. 4, another example of a request for transfer of host image data 38 at a different point in time is shown. The host requests the fetching of a frame of host image data 38, designated by reference number 304 and also denoted “HST FRM 1 RD.” The host requests the fetching at a time of CAM CLK cycle 51, that is fetching of the host frame 304 begins as soon as the display interface finishes fetching main frame 302a. The display interface finishes fetching host frame 304 at T₀, which is at the end of clock 60. The display interface then begins fetching main frame 302b at the end of a latency period at T₁, which is shown in FIG. 4 to be at the end of clock 67. However, this fetching again does not start until after the storing of the main frame 300c begins at the end of clock 69. Again, either the image tearing or frame dropping artifacts described above will again occur.

Referring still to FIG. 4, it can be seen that if the latency period were shorter, that is, if it ended prior to the beginning of the storing of the camera frame 3 (300c), the fetching of camera frame 2 (302b) could be accomplished without corruption. For instance, if T₁ equals CAM CLK cycle 65 or earlier, camera frame 2 (302b) could theoretically be fetched without producing an image tearing artifact. However, if VSYNC is used to trigger the camera frame 2 (302b) transfer, T₁ would need to equal at least equal CAM CLK 62 or preferably earlier, or an artifact from frame dropping would still result. Thus, FIG. 4 shows that a shorter latency period does not necessarily solve the artifact problem.

In known systems, a prior art display interface writes image data at the pixel clock speed, as required by a traditional display panel. It is not possible to transmit image data to a traditional display panel at a rate faster than the pixel clock. In contrast, in the system 20, the display devices 22 and 24 have an internal memory and are capable of receiving data at clock speeds which are faster than the pixel clock speed. It might be thought that the timing of host requests for fetching and writing host image data from the memory to panel could be accommodated without creating image tearing or frame dropping artifacts simply by transmitting data on the data bus 54 at a higher rate.

However, transmitting image data at a higher speed is not a viable solution. As the speed of the bus between the graphics controller and the panel increases, electromagnetic interference (“EMI”) with other components of the graphics display system is generated. In particular, a mobile telephone includes a radio (not shown), that is susceptible to EMI. Further, power consumption increases with bus speed. Thus, it is generally desired to transfer image data to the panels at the lowest clock speed possible.

The display interface 40 advantageously transmits image data to the display devices at the minimally sufficient clock speed. In particular, the display interface 40 preferably writes image data at the pixel clock speed on the data bus 54 between the graphics controller 26 and the display panels 22 and 24. Other clock speeds are of course possible, and in some embodiments, may be preferred. However, other preferred clock speeds are sufficiently slow so that they do not create EMI. As one example of an alternative, the display interface 40 write image data on the data bus 54 at 1.25 times the pixel clock speed.

According to one preferred embodiment of the invention, the novel display interface 40 supports two display panels without creating image tearing, frame dropping, or other undesirable artifacts, and without increasing the data transmission rate and thereby creating undesirable EMI. The display interface 40 makes advantageous use of all of the available bandwidth of data bus 42 despite the fact that the timing of host requests to fetch host image data are uncertain, or that the latency period may vary.

FIG. 5 is a timing diagram for the graphics display system 20, according to a preferred embodiment of the invention, showing host image data 38 transfer requests at different points in time. In the examples, a frame 304 of host image data 38 is again assumed to be 5 pixels in size. In addition, the figure also shows the same storing and fetching from the memory 34 of the camera image data 36 that is shown in FIG. 2. Again, it should be noted that the examples of FIG. 5 are presented for purposes of illustration.

In the examples of FIG. 5, the host 28 requests the transfer of host image data 38 at three different times. First, the host requests the transfer of host frame 1 (304a) at CAM CLK cycle 38. Next, the host requests the transfer of host frame 2 (304b) at CAM CLK cycle 89. Finally, the host requests the transfer of host frame 3 (304a) at CAM CLK cycle 146. It can be seen that these requests come at different times relative to the regular fetching of the camera image data. The first request is made in the middle of fetching camera frame 1 (302a). The second request is made in the time between the fetching of camera frame 2 (302b) and camera frame 3 (302c). The third request is made near the end of fetching camera frame 4 (302d).

The display interface 40 fetches camera image data 302 at a standard rate at times when the host or A/F module 43 have not made a request for the transfer of a host frame. The “standard” rate is preferably a rate typically required by a traditional display device. As shown in the examples, the standard rate is preferably the pixel clock rate. For example, the entirety of the camera frame 2 (302b) is fetched at the pixel clock rate. In addition, the un-shaded portions of the camera frames 1, 3, and 4 are also fetched at the standard rate. The un-shaded portions represent periods when no fetching of host image data is taking place.

Similarly, the display interface 40 fetches host image data 304 at the standard rate at times when camera image data 302 is not being fetched, that is, during the available bandwidth periods shown in FIG. 2. It can be seen that the latency period is advantageously eliminated (or substantially reduced) thereby permitting all of the available bandwidth to be used. The un-shaded portions of the host frames 2 and 3 (304b and 304c) represent periods when no fetching of camera image data is taking place.

At times when the host or the auto-frame transfer module 43 have made a request for the transfer of a host frame, the display interface 40 fetches camera image data at a rate slower than the standard rate. In one preferred embodiment, the slower rate is equal to ½ the pixel clock rate. In other words, the display interface 40 dynamically slows the fetching and transmitting of frames of camera image data 36 when a request for the transfer of a host frame occurs. The display interface 40 reduces the camera data fetch rate at substantially the same time that the host data transfer is made. In addition, the display interface 40 substantially concurrently begins fetching and transmitting of frames of host image data 38. Preferably, the display interface 40 fetches the host image data at the same slower rate, e.g., ½ the pixel clock rate.

During periods when both camera and host image data are being fetched, the display interface 40 alternates between fetching and transmitting portions of the camera image data 36 and host image data 38. (Periods when both camera and host image data are being fetched are shaded in FIG. 5.) Preferably, one pixel of camera image data 36 is fetched and transmitted to display 22, and then one pixel of host image data 38 is fetched and transmitted to display 24, and so on. The invention, however, is not limited to interleaving specific portions of image data such as a pixel. Generally, the portions will be substantially smaller than a full frame, but as examples, may be 2 or 3 pixels, or a display line of pixels. Moreover, there is no limitation that the portions be equal for each source of image data. For example, in some embodiments it may be advantageous to alternately fetch 2 pixels of camera image data 36 and 1 pixel of host image data 38. For instance, it may be advantageous to fetch larger portions of data from one source where a new frame from such source is being written faster than a previous frame is being fetched and it is determined that the fetching “head start” is not large enough to prevent the writing of the new frame from over taking the fetching of the previous frame.

The display interface 40 preferably includes logic for detecting a request for fetching and transmitting host image data to a display, for alternately fetching one pixel of camera image data 36 and one pixel of host image data 38, and alternately transmitting the fetched pixels to the display devices. Further, the rate controller 41 is either included in the display interface 40 or coupled to it. The rate controller 41 is adapted to adjust the rate at which the display interface 40 fetching and transmitting host and camera image data. The rate controller 41 may adjust the rate in response to detecting VSYNC while host image data is being fetched, to the host requests a transfer of host image data while host image data is being fetched, or to substitute signals provides by counting image data as it is being stored. It will be appreciated by one skilled in the art that this logic may be implemented in a variety of different ways. In one preferred embodiment, the “logic” is embodied as a program of instructions for performing a method according to the invention, which is executable by a machine, such as a microprocessor.

It can be seen from FIG. 5 that the fetching of each camera frame 302 always begins before the storing of a subsequent camera frame. The fetching of each camera frame 302 begins substantially immediately following the completion of the storing of that frame notwithstanding that the fetching of a host frame may be in progress. See, for example, the fetching of host frame 2 (304b). Thus, it can be seen that the invention satisfies the first of the requirements described above for limiting the size of the camera frame memory, namely, that the fetching of each frame must begin before the storing of a subsequent frame. The present invention also advantageously permits the VSYNC signal to be used to trigger camera frame transfers. In other words, the auto-frame transfer 43 is need not be disabled, avoiding the possibility that it will miss a VSYNC signal and thereby eliminating frame dropping artifacts.

It will be recalled that the second of the requirements described above for limiting the size of the camera frame memory is that, generally speaking, the camera image data must be stored at a rate slower than the rate at which the camera image data is fetched. The invention does not necessarily satisfy this second general requirement. However, this does not prevent a problem. Provided that the fetching begins sufficiently prior to the storing of subsequent data (providing a “head start”) so that, even though a new frame is being written faster than the previous frame is being fetched, the head start will be large enough that the writing will not over take the reading before the fetching of the host image data is complete. When the fetching of the host image data is complete, the display interface 40 reverts to fetching camera data at the standard clock rate.

While it is preferably to use the VSYNC signal trigger camera frame transfers, this is not required. It should be understood that in an alternative preferred embodiment, image data may be counted as it is stored thereby providing a measure of storing progress. The counter may be adapted to generate a suitable substitute signal after a predetermined or programmable percent of the camera frame is stored. In one preferred embodiment, the fetching of camera frames from memory is begun once 80 of the frame has been stored. Similarly, the signal which triggers the transfer of host frames may be an explicit signal from the host or a signal produced as the result of a measure of storage progress, and such signal need not be asserted only upon completion of storing.

Another advantage is that when the host 26 requests a transfer of host image data, the transfer begins substantially immediately. The graphics controller can acknowledge the host's request and the host can terminate its involvement knowing that the transfer is in process.

The invention is not limited to the exemplary transfers of (a) camera image data 36 to the main display 22; and (b) host image data 38 to auxiliary display 24. In one alternative embodiment, (a) camera image data 36 is transferred to the auxiliary display 24; and (b) host image data 38 to the main display 22. Moreover, the camera image data 36 may be comprised of image data of image data provided by two or more sources, such as by both the host and the camera. Similarly, the host image data 38 may originate from two or more sources.

In yet another alternative embodiment, the same image data, for example, camera image data 36, may be transferred to a plurality of display devices, for instance, to both displays 22 and 24. This provides, for such transfers, the advantage of increasing the timing margin and thereby eliminating the possibility of undesirable image tearing artifacts.

The buses described herein are preferably fixed electrically conductive traces known in the art of IC design. However, it should be appreciated that the described buses, such as the data bus 54, may also be wireless or optical.

The terms and expressions that have been employed in the foregoing specification are used as terms of description and not of limitation, and are not intended to exclude equivalents of the features shown and described or portions of them. The scope of the invention is defined and limited only by the claims that follow.

We claim:

1. A method for fetching image data from a memory for transmission on a data bus to at least two display devices, comprising the steps of:
fetching first portions of a first frame at a non-interleaving fetch rate in response to receiving a first signal;
fetching second portions of a second frame at the non-interleaving fetch rate in response to receiving a second signal, the timing of the first and second signals being asynchronous to one another; and
adjusting the non-interleaving fetch rate to an interleaving fetch rate in response to performing said step of fetching second portions.

2. The method of claim 1, further comprising adjusting the interleaving fetch rate to a non-interleaving fetch rate in response to fetching one of: a last first portion of the first frame, and a last second portion of the second frame.

3. The method of claim 2, wherein the first portions are one pixel.

4. The method of claim 3, wherein the first portions and the second portions each comprise the same number of pixels.

5. The method of claim 3, wherein the first portions and the second portions each comprise different numbers of pixels.

6. The method of claim 1, wherein said steps of fetching first and second portions each begin substantially immediately following receipt of the respective first and second signals.

7. The method of claim 1, wherein the first signal is a VSYNC signal.

8. The method of claim 1, wherein the interleaving fetch rate is less than the non-interleaving fetch rate.

9. A graphics controller for fetching image data for transmission on a data bus to at least two display devices in response to receipt of respective signals for each of the display devices, at least one of the signals being generated asynchronously to the other signals, comprising:
a memory for storing first and second frames of image data;
a display interface for fetching first portions of a first frame at a non-interleaving fetch rate in response to detection a first signal, and fetching second portions of a second frame at the non-interleaving fetch rate in response to detection of a second signal; and
a rate controller for adjusting the non-interleaving fetch rate to an interleaving fetch rate in response to detection of the second signal while fetching first portions.

10. The graphics controller of claim 9, wherein the second signal is generated upon the completion of storing of the second frame of image data in said memory.

11. The graphics controller of claim 9, wherein the second signal is generated before the completion of storing of the second frame of image data in said memory.

12. The graphics controller of claim 9, wherein said rate controller is further adapted for adjusting the interleaving fetch rate to the non-interleaving fetch rate in response to fetching one of: a last first portion of the first frame, and a last second portion of the second frame.

13. The graphics controller of claim 9, wherein said display interface is adapted to fetch first and second portions immediately following receipt of the respective first and second signals.

14. The graphics controller of claim 13, wherein the interleaving fetch rate is less than the non-interleaving fetch rate.

15. A graphics display system for transmitting image data from at least two image sources to at least two display devices, comprising:
a first data source for generating a first frame of image data;
a second data source for generating a second frame of image data, said second data source generating image data asynchronously to said first data source;
a first display device;
a second display device; and
a graphics controller coupled with said first and second data sources, and with said first and second display devices, the graphics controller including:
a memory for storing the first and second frames;
a display interface for fetching from said memory first portions of the first frame at a non-interleaving fetch rate upon the completion of storing of the first frame in said memory, and fetching second portions of the second frame at the non-interleaving fetch rate upon the completion of storing of the second frame in said memory; and
a rate controller for adjusting the non-interleaving fetch rate to an interleaving fetch rate upon the completion of storing of the second frame while fetching first portions.

16. The graphics display system of claim 15, wherein said rate controller is further adapted for adjusting the interleaving fetch rate to the non-interleaving fetch rate in response to fetching one of: a last first portion of the first frame, and a last second portion of the second frame.

17. The graphics display system of claim 15, wherein said display interface is adapted to fetch first and second portions immediately upon the respective completions of storing of the first and second frames in said memory.

18. The graphics display system of claim 15, wherein the interleaving fetch rate is less than the non-interleaving fetch rate.

19. The graphics display system of claim 15, wherein said first data source is a host and said second data source is a camera.

20. The graphics display system of claim 15, wherein said first display device includes a memory for storing a first display frame and said second display device includes a memory for storing a second display frame.
